(19) United States
(12) Patent Application Publication
(10) Pub. No.: US 2008/0008101 A1
(43) Pub. Date: Jan. 10, 2008

(54) Computer-readable medium storing test support program, test support apparatus, and test support method

(75) Inventors: Yuji Yamaoka, Kawasaki (JP); Ikuya Morikawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/642,929

(22) Filed: Dec. 21, 2006

(30) Foreign Application Priority Data
Jul. 4, 2006 (JP) 2006-184975

(51) Int. Cl. H04L 12/26

(52) U.S. Cl. 370/241

(57) ABSTRACT

A computer-readable medium storing a test support program capable of automating generation of test requests to a Web server, including a request the contents of which cannot be outputted by a browser, a test support apparatus, and a test support method. A default request generation section generates request data for accessing a page to be tested on the basis of link identification information stored in a link identification information storage section and outputs the request data generated as a default request. A test request generation section generates a test request by performing editing on the default request outputted from the default request generation section in accordance with contents of a manipulation regarding data to be changed indicated by differential manipulation data stored in a differential manipulation data storage section. A request sending section sends the test request.

### CROSS-REFERENCE TO RELATED APPLICATIONS

This application is based upon and claims the benefits of priority from the prior Japanese Patent Application No. 2006-184975, filed on Jul. 4, 2006, the entire contents of which are incorporated herein by reference.

### BACKGROUND OF THE INVENTION

(1) Field of the Invention

This invention relates to a computer-readable medium storing a test support program for supporting a test for the function of a server, a test support apparatus, and a test support method and, more particularly, to a computer-readable medium storing a test support program for automatically generating data inputted via a network, a test support apparatus, and a test support method.

(2) Description of the Related Art

With the spread of local area networks and wide area networks, various kinds of services can be provided now via networks. In addition, World Wide Web (WWW) browsers are installed now on most of client computers. Accordingly, if a server computer (hereinafter referred to as a Web server) on which a program for providing a Web page is installed is used for providing services, there is no need to install a special program on the client side, resulting in easy system installation. Therefore, various business oriented application programs (hereinafter simply referred to as applications) which are executed on a Web server are developed.

When a business oriented application for WWW servers is developed, it is necessary to check before the beginning of the practical use that the application operates normally. Usually operation has been checked manually in the case of an application involving inputting and outputting with a graphical user interface (GUI). However, if operation is checked manually, a mistake in inputting may occur when data is inputted on the basis of specifications. Moreover, diverse items are inputted for many screen display programs. As a result, it takes a very long time to manually input all patterns.

In addition, the same test may be repeated to check operation. However, to manually repeat the same test is not efficient. Furthermore, whether or not the results of a test performed the last time differ from those of a test performed this time is checked visually, so the possibility of a result not being checked always exists.

Therefore, techniques for supporting a test by automatically performing operation on a Web browser with a GUI are proposed. One of these techniques is as follows. A script file is generated on the basis of an event which occurs according to operation performed on a Web browser. The input event which was performed on the Web browser is reproduced on the basis of the script file. By doing so, a recursive test is supported. The script file can be edited in a text format. Accordingly, by editing a value to be inputted into an input field by an editor, the edited value can be inputted into a device. That is to say, a script file is generated for each test input and a group of script files are inputted to the device. By doing so, a plurality of test inputs can be automated (see, for example, Japanese Unexamined Patent Publication No. 2005-266954).

With the technique for automating operation input to the Web browser which is disclosed in Japanese Unexamined Patent Publication No. 2005-266954, however, tests can be carried out only for operation which can be performed on the browser. Accordingly, tests for security cannot be performed adequately.

For example, specially important tests for security include changing a hidden parameter value and adding a new parameter. That is to say, an evil-minded third party adds a parameter which is not set in request data outputted from an ordinary browser to a request. He/she sends the request to a Web server to cause a malfunction in the Web server. To check safety from such an act, it is desirable that data which is not outputted by operation input to a Web browser can be sent to the Web server as test data.

The following method may be adopted as a method for using data which is not outputted from a Web browser as test data. A request outputted from a Web browser is relayed, the contents of a parameter and the like are edited in real time by an editor, and the request is sent to a Web server. However, this method uses real time editing and cannot cope with batch processing. That is to say, if a series of candidate test inputs is known, a unit is given instructions to perform batch processing for the purpose of automating a series of test inputs. However, editing by a user intervenes, so it is impossible to automate a test by batch processing.

### SUMMARY OF THE INVENTION

The present invention was made under the background circumstances described above. An object of the present invention is to provide a computer-readable medium storing a test support program capable of automating generation of test requests to a Web server, including a request the contents of which cannot be outputted by a browser, a test support apparatus, and a test support method.

In order to achieve the above object, a computer-readable medium storing a test support program for supporting a test for a page provided by a server on a network is provided. The program causing a computer to function as a link identification information acquisition section for accepting input of link identification information necessary for tracing a link from a link source page to a page to be tested, a link identification information storage section for storing the link identification information inputted to the link identification information acquisition section, a differential manipulation data acquisition section for accepting input of differential manipulation data indicative of contents of a manipulation performed on data to be changed included in a default request, a differential manipulation data storage section for storing the differential manipulation data inputted to the differential manipulation data acquisition section, a default request generation section for generating request data for accessing the page to be tested on the basis of the link identification information stored in the link identification information storage section and for outputting the request data generated as the default request, a test request generation section for generating a test request by performing editing on the default request outputted from the default request generation section in accordance with the contents of the manipulation regarding the data to be changed indicated by the differential manipulation data stored in the differential manipulation data storage section, and a request sending section for sending the test request generated by the test request generation section via the network.

Furthermore, in order to achieve the above object, a test support apparatus for supporting a test for a page provided by a server on a network is provided. This test support apparatus comprises a link identification information acquisition section for accepting input of link identification information necessary for tracing a link from a link source page to a page to be tested, a link identification information storage section for storing the link identification information inputted to the link identification information acquisition section, a differential manipulation data acquisition section for accepting input of differential manipulation data indicative of contents of a manipulation performed on data to be changed included in a default request, a differential manipulation data storage section for storing the differential manipulation data inputted to the differential manipulation data acquisition section, a default request generation section for generating request data for accessing the page to be tested on the basis of the link identification information stored in the link identification information storage section and for outputting the request data generated as the default request, a test request generation section for generating a test request by performing editing on the default request outputted from the default request generation section in accordance with the contents of the manipulation regarding the data to be changed indicated by the differential manipulation data stored in the differential manipulation data storage section, and a request sending section for sending the test request generated by the test request generation section via the network.

In addition, in order to achieve the above object, a test support method for supporting a test for a page provided by a server on a network is provided. This test support method comprises the steps of a link identification information acquisition section accepting input of link identification information necessary for tracing a link from a link source page to a page to be tested, and the link identification information acquisition section storing the link identification information inputted in a link identification information storage section; a differential manipulation data acquisition section accepting input of differential manipulation data indicative of contents of a manipulation performed on data to be changed included in a default request, and the differential manipulation data acquisition section storing the differential manipulation data inputted in a differential manipulation data storage section; a default request generation section generating request data for accessing the page to be tested on the basis of the link identification information stored in the link identification information storage section, and the default request generation section outputting the request data generated as the default request; a test request generation section generating a test request by performing editing on the default request outputted from the default request generation section in accordance with the contents of the manipulation regarding the data to be changed indicated by the differential manipulation data stored in the differential manipulation data storage section; and a request sending section sending the test request generated by the test request generation section via the network.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for giving an overview of an embodiment of the present invention.

FIG. 2 shows an example of the configuration of a system according to an embodiment of the present invention.

FIG. 3 shows an example of the hardware configuration of a computer used in the embodiment of the present invention.

FIG. 4 is a block diagram showing the function of a test support apparatus.

FIG. 5 shows the data structure of a URL and a parameter.

FIG. 6 shows the relationship between a page class and link identification information.

FIG. 7 shows a link identification information group stored in a link identification information storage section.

FIG. 8 shows an example of a test definition.

FIG. 9 is a flow chart showing the procedure for a process performed by a test input section.

FIG. 10 is a flow chart showing the procedure for a default request generation process.

FIG. 11 is a flow chart showing the procedure for a page reproduction process.

FIG. 12 is a flow chart showing the procedure for a link selection process.

FIG. 13 shows an example of a response to a request.

FIG. 14 shows a list of links included in a response.

FIG. 15 shows an example of request data.

FIG. 16 is a flow chart showing the procedure for a differential manipulation application process.

FIG. 17 shows a differential manipulation main screen.

FIG. 18 shows a detail editing screen.

FIG. 19 shows a partial manipulation input screen.

### DESCRIPTION OF THE PREFERRED EMBODIMENTS

Embodiments of the present invention will now be described with reference to the drawings.

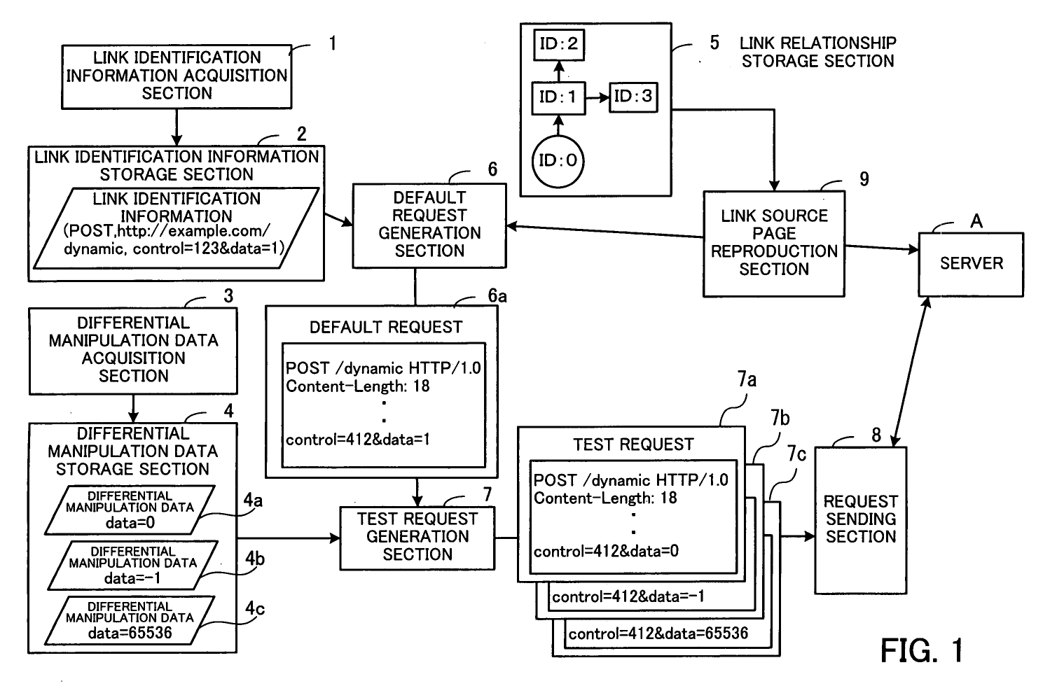

FIG. 1 is a view for giving an overview of an embodiment of the present invention. In an embodiment of the present invention, a link identification information acquisition section 1, a link identification information storage section 2, a differential manipulation data acquisition section 3, a differential manipulation data storage section 4, a link relationship storage section 5, a default request generation section 6, a test request generation section 7, a request sending section 8, and a link source page reproduction section 9 are included as main functions for supporting a test for a page provided by a server A on a network.

The link identification information acquisition section 1 accepts input of link identification information necessary for tracing a link from a link source page to a page to be tested. For example, the link identification information acquisition section 1 acquires link identification information by operation input from a user. In addition, the link identification information acquisition section 1 accepts operation input for selecting a link relationship stored in the link relationship storage section 5 and can acquire link identification information indicative of the selected link relationship from the link relationship storage section 5. The link identification information acquisition section 1 stores the link identification information it acquired in the link identification information storage section 2.

The link identification information storage section 2 stores the link identification information inputted to the link identification information acquisition section 1. The link identification information stored in the link identification information storage section 2 is deleted after the default request generation section 6 generates a default request 6a.

The differential manipulation data acquisition section 3 accepts input of differential manipulation data 4a, 4b, and 4c indicative of the contents of a manipulation performed on data to be changed included in the default request. For example, the differential manipulation data 4a, 4b, and 4c are inputted by operation input from a user. Data to be changed is designated by, for example, parameter names in the differential manipulation data 4a, 4b, and 4c. “add,” “change,” “delete,” or the like is designated as the contents of a manipulation. If the type of a manipulation is “adding” or “changing” parameters, the values of the parameters after the manipulation are set in the differential manipulation data 4a, 4b, and 4c. The differential manipulation data acquisition section 3 stores the differential manipulation data 4a, 4b, and 4c it acquired in the differential manipulation data storage section 4.

The differential manipulation data storage section 4 stores the differential manipulation data 4a, 4b, and 4c inputted to the differential manipulation data acquisition section 3. If plural pieces of differential manipulation data are applied to the default request 6a to generate one test request, the plural pieces of differential manipulation data to be concurrently applied are stored in block in the differential manipulation data storage section 4 as a differential manipulation data group.

The link relationship storage section 5 stores in advance the link relationship between pages provided by the server A. For example, by collecting and analyzing in advance pages in the server A, link relationships among the pages can be stored in the link relationship storage section 5. Information indicative of which page calls which page, the contents of link identification information set in a link source page (call source page) for the call, and the like are set as link relationship.

For example, a technique for collecting pages from a Web server and classing pages the contents of which are the same in the same category is disclosed in Japanese Unexamined Patent Publication No. 2006-58966. To be concrete, when pages are collected, a hypertext transfer protocol (HTTP) response is parsed, a link is automatically detected, and HTTP request data is generated from link identification information. In this case, identification data (ID) for the link is recorded. In Japanese Unexamined Patent Publication No. 2006-58966, ID is given to a page class which is the classification unit of the pages. Link identification information corresponding to each page class is represented by a combination of “link source page class ID” and a “link uniform resource locator (URL)”. A link URL is represented by a combination of a “request method corresponding to the type of a link,” a “URL,” and “form data”. Link identification data used for reproducing each page class is recorded therein.

The conditions of the classification can be set arbitrarily. For example, pages called by the same URL may be classed in the same category. Pages called by the same URL and requests in which a parameter having the same name is set may be classed in the same category.

The default request generation section 6 generates request data for accessing the page to be tested on the basis of the link identification information stored in the link identification information storage section 2. The default request generation section 6 outputs the request data generated as the default request 6a.

The test request generation section 7 generates test requests 7a, 7b, and 7c by performing editing operation on the default request 6a outputted from the default request generation section 6 in accordance with the contents of the manipulation regarding the data to be changed indicated by the differential manipulation data 4a, 4b, and 4c stored in the differential manipulation data storage section 4.

The request sending section 8 sends the test requests 7a, 7b, and 7c generated by the test request generation section 7 via the network.

The link source page reproduction section 9 determines the link source page by referring to link relationship storage section 5, and reproduces the link source page by accessing the server A.

By making a computer execute the above test support program, input of the link identification information is accepted by the link identification information acquisition section 1 and the link identification information is stored in the link identification information storage section 2. Input of the differential manipulation data 4a, 4b, and 4c is accepted by the differential manipulation data acquisition section 3 and the differential manipulation data 4a, 4b, and 4c are stored in the differential manipulation data storage section 4. The default request generation section 6 then generates the request data for accessing the page to be tested on the basis of the link identification information stored in the link identification information storage section 2. The request data generated is outputted as the default request 6a. In this case, the default request generation section 6 can generate the request data directly from the link identification information. However, the default request generation section 6 may generate the request data by using the page reproduced by the link source page reproduction section 9.

When the link source page reproduction section 9 reproduces the link source page, the default request generation section 6 issues a link source page reproduction request to the link source page reproduction section 9. The link source page reproduction section 9 refers to link relationship storage section 5 and determines ID for a page class that is a link source for a page class to which the link identification information stored in the link identification information storage section 2 belongs. The link source page reproduction section 9 then reproduces the link source page by using a link URL of the page class that is the link source.

The link source page reproduced is passed to the default request generation section 6. The default request generation section 6 analyzes the link source page and extracts a link URL corresponding to the link URL defined in the link identification information stored in the link identification information storage section 2. The default request generation section 6 then generates the request data on the basis of the link URL extracted from the link source page and outputs it as the default request 6a.

The value of a parameter (“control,” for example) changes each time the server A is accessed. By using the link URL extracted from the reproduced link source page in this way, however, a value at the time of a test being performed can be used. In the example shown in FIG. 1, “control=123” if the link identification information stored in the link identification information storage section 2 is used for generating the request data. However, if the link URL extracted from the reproduced link source page is used, the value “control=412” sent from the server A at the time of reproducing the link source page is set.

The test request generation section 7 then generates the test requests 7a, 7b, and 7c by performing editing operation on the default request 6a outputted from the default request generation section 6 in accordance with the contents of the manipulation regarding the data to be changed indicated by the differential manipulation data 4a, 4b, and 4c stored in the differential manipulation data storage section 4. For example, “data=0” is set in the differential manipulation data 4a, so the test request 7a is generated by changing the parameter “data” in the default request 6a to “0”.

The request sending section 8 sends the test requests 7a, 7b, and 7c generated to the server A.

By analyzing the contents of responses from the server A to the test requests 7a, 7b, and 7c, whether pages in the server A function as designed can be checked. Moreover, it is possible to check that when an incorrect parameter is sent, a security hole does not appear. For example, even if only “1” and “2” can be set as the values of “data” for operation input to a browser which displays the link source page, incorrect values such as “0,” “−1,” and “65536” can be set by using the embodiment of the present invention.

By performing such a test, the safety of the server A from an evil-minded third party who unlawfully accesses the server A can easily be tested. In addition, by providing the differential manipulation data 4a, 4b, and 4c, differential manipulation is automatically applied to the default request 6a. This enables automation by batch processing.

By the way, to realize automation by batch processing, it is desirable that test result can automatically be decided. Accordingly, an embodiment of the present invention will be described in detail by using an example of a system which can also automate the decision of test result.

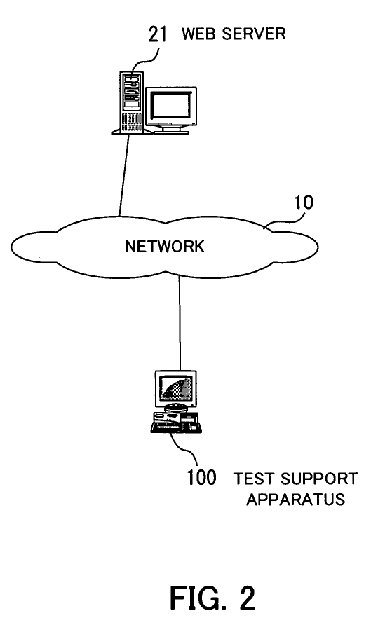

FIG. 2 shows an example of the configuration of a system according to an embodiment of the present invention. A test support apparatus 100 is connected to a Web server 21 via a network 10. For example, if a program installed on the Web server 21 is updated, the operation of the Web server 21 can be tested by sending a test request from the test support apparatus 100 to the Web server 21.

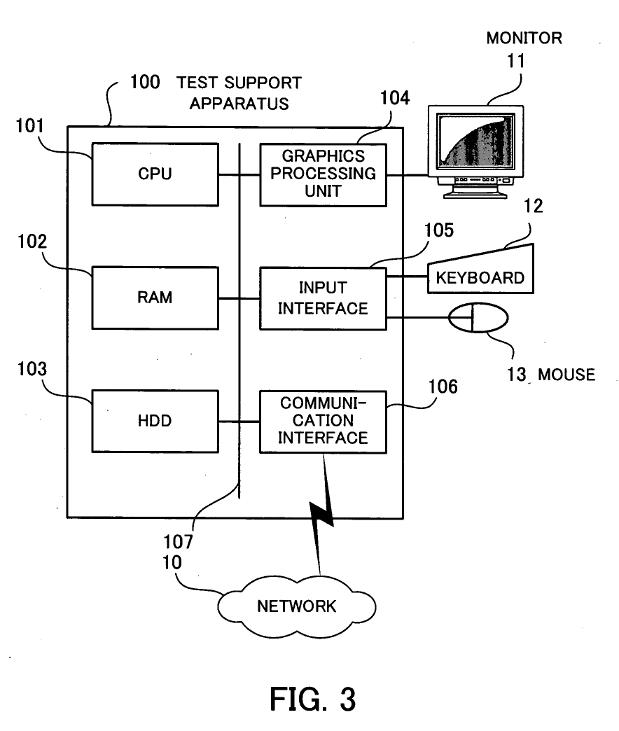

FIG. 3 shows an example of the hardware configuration of a computer used in the embodiment of the present invention. The whole of the test support apparatus 100 is controlled by a central processing unit (CPU) 101. A random access memory (RAM) 102, a hard disk drive (HDD) 103, a graphics processing unit 104, an input interface 105, and a communication interface 106 are connected to the CPU 101 via a bus 107.

The RAM 102 temporarily stores at least part of an operating system (OS) or an application program executed by the CPU 101. The RAM 102 also stores various pieces of data which the CPU 101 needs to perform a process. The HDD 103 stores the OS and application programs.

A monitor 11 is connected to the graphics processing unit 104. In accordance with instructions from the CPU 101, the graphics processing unit 104 displays an image on a screen of the monitor 11. A keyboard 12 and a mouse 13 are connected to the input interface 105. The input interface 105 sends a signal sent from the keyboard 12 or the mouse 13 to the CPU 101 via the bus 107.

The communication interface 106 is connected to a network 10. The communication interface 106 exchanges data with another computer via the network 10.

By adopting the above-mentioned hardware configuration, the processing function of this embodiment can be realized. In FIG. 3, the hardware configuration of the test support apparatus 100 is shown. However, the Web server 21 can also be realized by adopting the same hardware configuration.

A function which the test support apparatus 100 needs for testing a Web page will now be described.

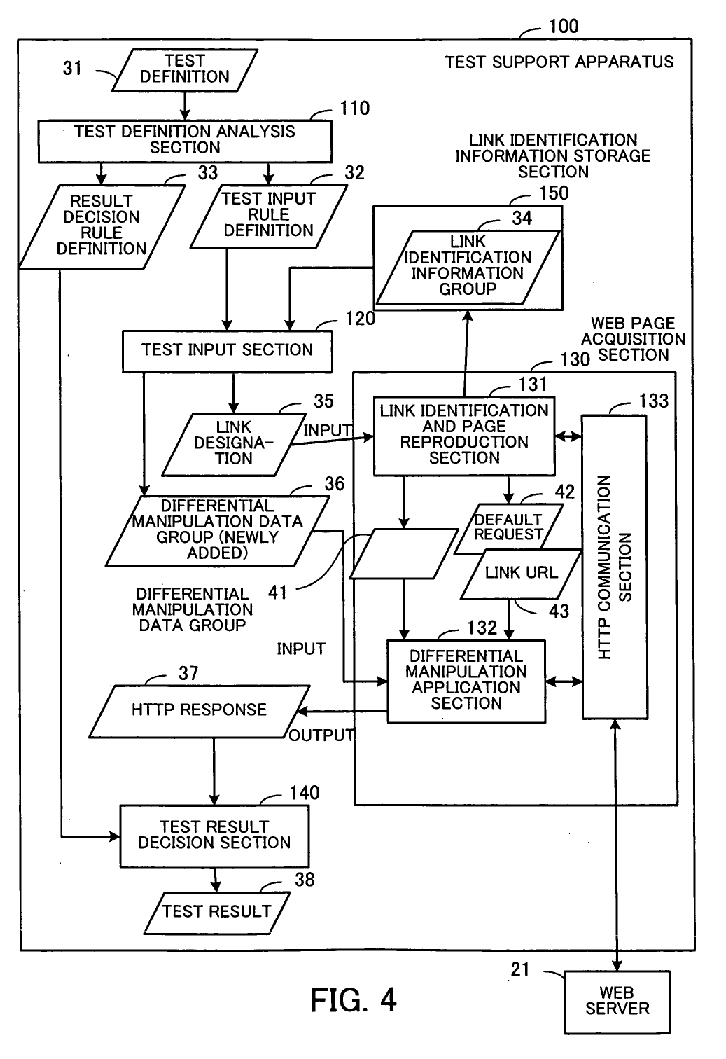

FIG. 4 is a block diagram showing the function of the test support apparatus. The test support apparatus 100 includes a test definition analysis section 110, a test input section 120, a Web page acquisition section 130, a test result decision section 140, and a link identification information storage section 150.

The test definition analysis section 110 accepts input of a test definition 31 by, for example, operation input and analyzes the test definition 31 inputted. The test definition 31 is used for defining the contents of a test, and includes a test input rule definition 32 for defining rules for setting data to be inputted at the time of the test and a result decision rule definition 33 for defining criteria for deciding whether test results are good. The test definition analysis section 110 separates the test definition 31 inputted into the test input rule definition 32 and the result decision rule definition 33. The test definition analysis section 110 passes the test input rule definition 32 to the test input section 120 and passes the result decision rule definition 33 to the test result decision section 140.

The test input section 120 acquires a link identification information group 34 designated by, for example, operation input from the link identification information storage section 150. The test input section 120 accepts the test input rule definition 32 from the test definition analysis section 110 and performs a process on each piece of link identification information included in the link identification information group 34 acquired in accordance with the test input rule definition 32.

That is to say, the test input section 120 generates differential manipulation data regarding a target designated by the <target> tag in the test input rule definition 32 for each piece of link identification information by using a value designated by the <input_value> tag in the test input rule definition 32. In addition, the test input section 120 inputs the link identification information from which the differential manipulation data was generated to a link identification and page reproduction section 131 as link designation 35 and inputs plural pieces of differential manipulation data generated to a differential manipulation application section 132 as a differential manipulation data group 36.

The Web page acquisition section 130 accesses the Web server 21 and acquires a Web page to be tested. To be concrete, the Web page acquisition section 130 acquires a Web page indicated by the link designation 35.

Some Web pages cannot be acquired correctly if predetermined links are not traced. For example, a Web page which cannot be acquired without an authentication process such as logging in can be acquired only via a Web page for performing an authentication process. Accordingly, the Web page acquisition section 130 has the function of correctly acquiring a Web page by reproducing the procedure for acquiring up to the Web page indicated by the link designation 35.

The Web page acquisition section 130 also has the function of changing the contents of a request issued at the time of acquiring the Web page according to the differential manipulation data. To realize these functions, the Web page acquisition section 130 includes the link identification and page reproduction section 131, the differential manipulation application section 132, and an HTTP communication section 133.

The link identification and page reproduction section 131 reproduces the Web page indicated by the link designation 35 inputted by tracing predetermined links. This function can be realized by using the function of, for example, a “page information collection apparatus” disclosed in Japanese Unexamined Patent Publication No. 2006-58966. With the invention disclosed in Japanese Unexamined Patent Publication No. 2006-58966, Web pages are automatically collected from Web sites. The Web pages collected are classified according to data structure in accordance with predetermined classification rules. For example, Web pages the URLs of which are the same and which include the same link information for designating another Web page are considered to have the same data structure, and are placed into the same class. In addition, the “page information collection apparatus” stores information including a link relationship to be traced for reproducing a Web page which falls under an arbitrary class as the link identification information group 34.

The link identification and page reproduction section 131 includes the function of the “page information collection apparatus” disclosed in Japanese Unexamined Patent Publication No. 2006-58966. That is to say, the link identification and page reproduction section 131 traces links for reproducing the Web page indicated by the link designation 35 and reproduces a link source page for the Web page. The link identification and page reproduction section 131 then selects a link URL for acquiring the Web page indicated by the link designation 35 from the link source page. The link identification and page reproduction section 131 generates a request (default request 42) on the basis of the link URL it selected.

Furthermore, the link identification and page reproduction section 131 passes the default request 42, the link URL 43 used for generating the default request 42, and a differential manipulation data group 41 to be applied to the default request 42 to the differential manipulation application section 132. The differential manipulation data group 41 is recorded in the link identification and page reproduction section 131 as information which was used for collecting pages.

The differential manipulation application section 132 applies the differential manipulation data group 41 accepted from the link identification and page reproduction section 131 and the differential manipulation data group 36 accepted from the test input section 120 to the default request 42 inputted from the link identification and page reproduction section 131 to generate a test request on the Web page indicated by the link designation 35. If a differential manipulation is to be performed on form data, the default request 42 is searched for data corresponding to form data set in the link URL 43 which the differential manipulation application section 132 accepted with the default request 42, and the differential manipulation is to be performed on the data detected.

In addition, the differential manipulation application section 132 passes the request it generated to the HTTP communication section 133 and accepts an HTTP response 37 from the HTTP communication section 133. The differential manipulation application section 132 then passes the HTTP response 37 it accepted to the test result decision section 140.

The HTTP communication section 133 accepts the request data (including a URL as additional information) as input and sends the request data to the object Web server 21 by HTTP/HTTPS communication. The HTTP communication section 133 then outputs response data corresponding to the request data sent. This function can be realized by using, for example, the telnet which is generally well-known. By using this function, the HTTP communication section 133 accesses the Web server 21 in response to an HTTP request from the link identification and page reproduction section 131 or the differential manipulation application section 132 and acquires an HTTP response such as a Web page. The HTTP communication section 133 then passes the HTTP response it acquired to the link identification and page reproduction section 131 or the differential manipulation application section 132.

The test result decision section 140 evaluates the HTTP response 37 it accepted from the differential manipulation application section 132 on the basis of the result decision rule definition 33 it accepted from the test definition analysis section 110. For example, if information indicated by the result decision rule definition 33 is included in the HTTP response 37, then the test result decision section 140 makes the decision that the test is normally ended. The test result decision section 140 outputs the contents of the decision as a test result 38.

The link identification information storage section 150 stores the link identification information group 34 generated by the link identification and page reproduction section 131.

The functions other than the function of the server A shown in FIG. 1 are included in the Web page acquisition section 130. To be concrete, the functions of the link identification information acquisition section 1, the link identification information storage section 2, the link relationship storage section 5, the default request generation section 6, and the link source page reproduction section 9 are included in the link identification and page reproduction section 131. In addition, the functions of the differential manipulation data acquisition section 3, the differential manipulation data storage section 4, the test request generation section 7, and the request sending section 8 are included in the differential manipulation application section 132. However, the function of performing a communication process by using the HTTP which is included in the request sending section 8 and the link source page reproduction section 9 is realized by the HTTP communication section 133.

The data structure of a URL and a parameter and the link identification information group 34 will now be described before a process performed by each function shown in FIG. 4 is described in detail.

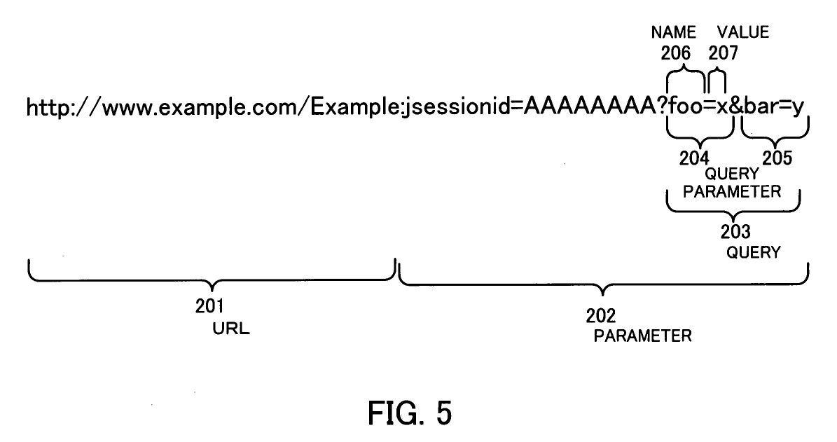

FIG. 5 shows the data structure of a URL and a parameter. A position where HTTP data resides is designated by a URL 201. A parameter 202 can be added to the URL 201. When the HTTP data designated by the URL 201 is acquired, the parameter 202 is passed to a Web server which holds the HTTP data. If a Web application is designated in the URL 201, a query 203 can be set after “?”. The query 203 includes one or more query parameters 204 and 205. The query parameter 204 has a name 206 and a value 207. In the case of the parameter 202 added to the URL 201, a differential manipulation is performed on each of the query parameters 204 and 205 included in the parameter 202.

Page classes and a link identification information group held by the link identification and page reproduction section 131 will now be described.

A link identification information group is generated on the basis of Web pages collected by a Web page collection function. The Web pages are divided into page classes according to data structure. A link URL used for acquiring a Web page which belongs to each page class and differential manipulation data are indicated in link identification information.

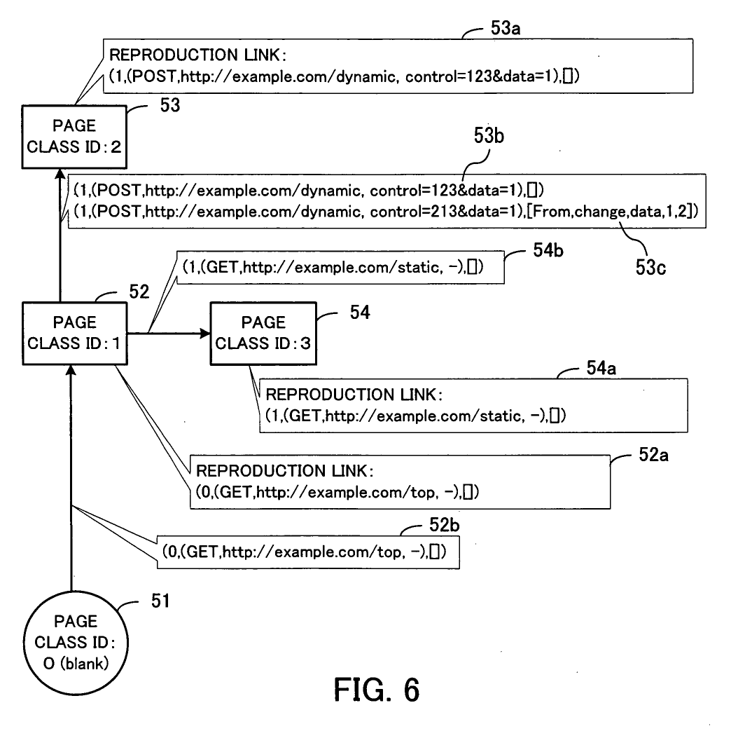

FIG. 6 shows the relationship between a page class and link identification information. Page class ID for uniquely identifying page classes is assigned to page classes 51 through 54 into which Web pages collected are divided.

Reproduction links 52a, 53a, and 54a are associated with the page classes 52 through 54, respectively, excluding the initial node. The reproduction links 52a, 53a, and 54a are typical link identification information for reproducing the corresponding page classes.

Link identification information 52b used for acquiring a page which belongs to the page class 52 is associated with the page class 52. Similarly, link identification information 53b and 53c used for acquiring a page which belongs to the page class 53 is associated with the page class 53 and link identification information 54b used for acquiring a page which belongs to the page class 54 is associated with the page class 54.

To make it possible to handle a request after applying a differential manipulation as a link used for another differential manipulation, the link identification information disclosed in Japanese Unexamined Patent Publication No. 2006-58966 is extended in the embodiment of the present invention. That is to say, link identification information is represented by a combination of “link source page class ID,” a “link URL,” and a “differential manipulation data group” in the embodiment of the present invention. A default request is generated by using the link source page class ID and the link URL, and is inputted to the differential manipulation application section with the differential manipulation data group.

Page class ID for the page class 51 is “0”. The page class 51 is the initial node and information regarding Web pages which belong thereto is blank. The initial node indicates a starting point for tracing link relationships among Web pages. The initial node corresponds to the state of a Web browser before reading a Web page by interactive operation by a user.

Page class ID for the page class 52 is “1”. Web pages which are directly read from the initial node belong to the page class 52. For example, a top page in the Web server 21 belongs to the page class 52. The reproduction link 52a of the page class 52 is “(0,(GET,http://example.com/top,-),[ ])”. “0” at the head of the reproduction link 52a is the page class ID for the page class 51 which is a link source.

“(GET,http://example.com/top,-)” in parentheses which follows the page class ID is a link URL. The letters “GET” in the link URL indicate a <request method> which is the method attribute of a request corresponding to the type of a link. “GET” indicates that the request is for acquiring a Web page. The URL “http://example.com/top” follows the type of the request. A field where form data is set follows the URL. In this example, however, form data is not set. Accordingly, the symbol “-” indicative of a blank is set. “[ ]” at the end of the reproduction link 52a indicates a field where differential manipulation data is set. In this example, the contents of the reproduction link 52a are used as the link identification information 52b “(0,(GET,http://example.com/top,-),[ ])” in their original condition.

Page class ID for the page class 53 is “2”. Web pages which are returned as HTTP responses in response to requests from the page class 52 belong to the page class 53. The reproduction link 53a of the page class 53 is “(1,(POST,http://example.com/dynamic,control=123&data=1),[])”. “1” at the head of the reproduction link 53a is the page class ID for the page class 52 which is a link source. The letters “POST” which follow the page class ID indicate the type of a request. “POST” indicates that the request is for setting data on a Web page. The URL “http://example.com/dynamic” follows the type of the request. In addition, parameters are set by “control=123&data=1”.

In order to access the page class 53 from a Web browser which displays the page class 52, request data to which differential manipulation data is not applied and request data to which differential manipulation data is applied are shown in this example. Accordingly, “(1,(POST,http://example.com/dynamic,control=123&data=1),[ ])” and “(1,(POST,http://example.com/dynamic,control=213&data=1),[Form,change,data,1,2])” are set as the link identification information 53b and 53c corresponding to the page class 53.

Information indicative of the link relationships among pages shown in FIG. 6 is stored in a storage unit managed by the link identification and page reproduction section 131. That is to say, the link identification and page reproduction section 131 stores the reproduction links associated with the page class ID and the link identification information for the page classes.

“[Form,change,data,1,2]” set in the link identification information is differential manipulation data. In the differential manipulation data, a <target>, a <type>, a <name>, a <order>, and a <value> are arranged in that order.

Information for specifying data to be changed in link identification information is indicated in the <Target> field. In the embodiment of the present invention, “Method,” “URL,” “Form,” “Query,” “Cookie,” “Referer,” or “Header” can be set in the <Target> field. There is a limit to a differential manipulation method for some of these targets. For example, the type of a manipulation is limited to “change all” for “Method,” “URL,” and “Referer”.

The type of a change process is indicated in the <Type> field. “add,” “change,” “delete,” “delete All,” or “change all” can be set in the <Type> field. “add” means adding a parameter. “change.” means changing the value of a predetermined parameter. “delete” means deleting a predetermined parameter. “delete all” means deleting all parameters. “change all” means that a change is limited only to changing all.

The name of a parameter to be changed is indicated in the <Name> field. Where the parameter to be changed is from the head of parameters having the same name is indicated in the <Order> field. A value to which the parameter to be changed is changed is indicated in the <Value> field.

For example, the differential manipulation data “[Form,change,data,1,2]” indicates that the value of the first parameter which has the name “data” and which is set as form data is changed to “2”.

Page class ID for the page class 54 is “3”. Web pages which are returned as HTTP responses in response to requests from the page class 52 belong to the page class 54. The reproduction link of the page class 54 is “(1,(GET,http://example.com/static,-),[ ])”. The link identification information corresponding to the page class 53 is also “(1,(GET,http://example.com/static,-),[ ])”.

The above page classes and link identification information are generated by the link identification and page reproduction section 131 and are stored in the link identification and page reproduction section 131 as page class information. The link identification and page reproduction section 131 extracts link identification information from the page class information, forms the link identification information group 34, and stores the link identification information group 34 in the link identification information storage section 150.

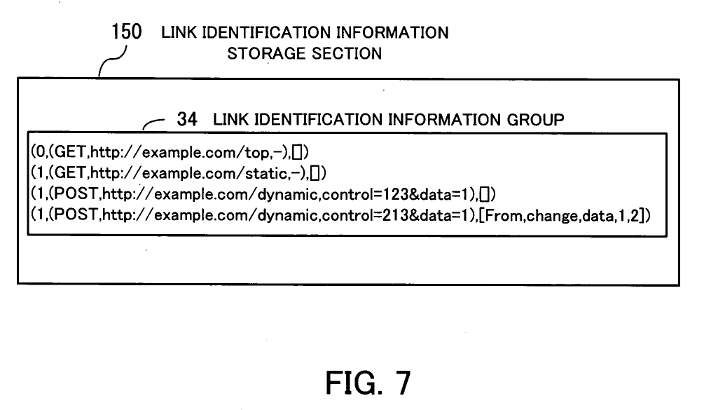

FIG. 7 shows a link identification information group stored in a link identification information storage section. As shown in FIG. 7, the link identification information group 34 is stored in the link identification information storage section 150.

Link identification information groups are stored in the link identification information storage section 150 according to, for example, Web site. When a Web page is tested, a link identification information group including link identification information regarding a page class to which the Web page to be tested belongs is designated by a user and is read out by the test input section 120.

When the Web page is tested, the user inputs the test definition 31 to the test definition analysis section 110.

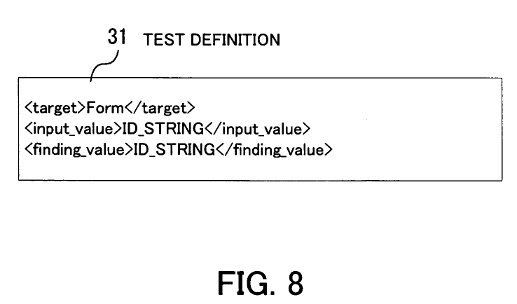

FIG. 8 shows an example of a test definition. The test definition 31 means that “send a test request in which the value ‘ID_STRING’ (designated by the <input_value> tag) is set for each ‘Form’ parameter (designated by the <target> tag), and output a response including ‘ID_STRING’ (designated by the <finding_value> tag) as a correct test result (link identification information, a differential manipulation data group, a request response, or the like)” for each of known pieces of link identification information.

The test definition analysis section 110 separates the test definition 31 inputted into the test input rule definition 32 and the result decision rule definition 33. To be concrete, the test definition analysis section 110 extracts the information designated by the <target> tag and the <input_value> tag shown in FIG. 8 from the test definition 31 and inputs the information to the test input section 120 as the test input rule definition 32. Furthermore, the test definition analysis section 110 extracts the information designated by the <finding_value> tag shown in FIG. 8 from the test definition 31 and inputs the information to the test result decision section 140 as the result decision rule definition 33.

The test definition 31 is inputted to the test definition analysis section 110 in this way. As a result, the test input rule definition 32 and the result decision rule definition 33 obtained by analyzing the test definition 31 are inputted to the test input section 120 and the test result decision section 140 respectively.

Furthermore, the user designates the page class to be tested and the link identification information group 34 including link identification information which designates the page class to be tested for the test input section 120. The test input section 120 then extracts the link identification information group 34 designated from the link identification information storage section 150. In addition, the test input section 120 generates the link designation 35 and the differential manipulation data group 36 on the basis of the test input rule definition 32 and the link identification information group 34.

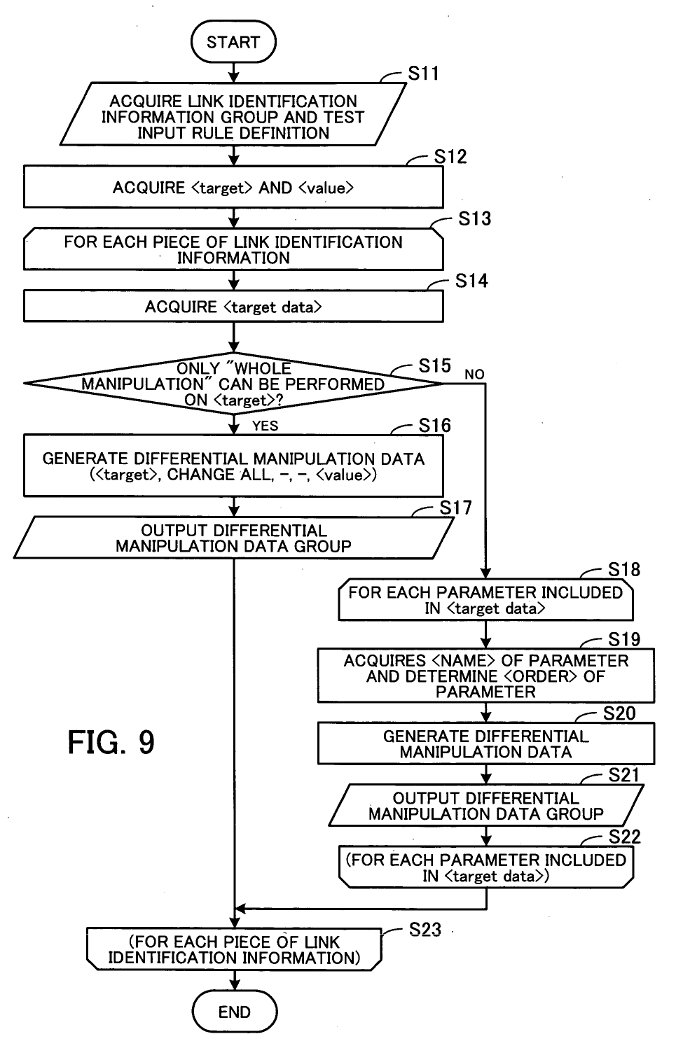

FIG. 9 is a flow chart showing the procedure for a process performed by the test input section. The process shown in FIG. 9 will now be described in order of step number.

[Step S11] The test input section 120 acquires the known link identification information group 34 designated and the test input rule definition 32.

[Step S12] The test input section 120 acquires a <target> and a <value> from the test input rule definition 32. In the example shown in FIG. 8, the <target> is designated by the <target> tag and the <value> is designated by the <input_value> tag.

[Step S13] The test input section 120 performs steps S14 through S22 for each piece of link identification information included in the link identification information group 34.

[Step S14] The test input section 120 acquires <target data> which is data designated in the <Target> field from link identification information.

[Step S15] The test input section 120 determines whether or not only “whole manipulation” can be performed on the <target>. That is to say, the test input section 120 determines whether or not information which indicates that only “whole manipulation” can be performed is set as the contents of the designation of the <target> in the test definition 31. For example, if a list of targets on which only “whole manipulation” can be performed is registered in advance and the contents of the <Target> field are included in this list, then the test input section 120 determines that only “whole manipulation” can be performed. If only “whole manipulation” can be performed, then step S16 is performed. Unless only “whole manipulation” can be performed, then step S18 is performed.

[Step S16] The test input section 120 generates differential manipulation data (<target>, change all, <value>) for the <target data>. If “change all” is performed, the contents of “change all” are set as the <value>. Accordingly, information for specifying a parameter to be changed is unnecessary, so the <Name> and <Order> fields are blank (indicated by the symbols “-”).

[Step S17] The test input section 120 outputs the link identification information processed to the link identification and page reproduction section 131 as the link designation 35 and outputs the differential manipulation data generated in step S16 to the differential manipulation application section 132 as the differential manipulation data group 36. Step S23 is then performed.

[Step S18] The test input section 120 performs steps S19 through S21 for each parameter included in the <target data>.

[Step S19] The test input section 120 acquires a <name> of a parameter and determines a <order> of the parameter (where the parameter is from the head of parameters having the same name).

[Step S20] The test input section 120 generates differential manipulation data (<target>, <change>, <name>, <order>, <value>) for the <target data>.

[Step S21] The test input section 120 outputs the link identification information processed to the link identification and page reproduction section 131 as the link designation 35 and outputs the differential manipulation data generated in step S20 to the differential manipulation application section 132 as the differential manipulation data group 36. Step S22 is then performed.

[Step S22] After the test input section 120 performs steps S19 through S21 for all parameters included in the <target data>, step S23 is performed.

[Step S23] After the test input section 120 performs steps S14 through S22 for all pieces of link identification information, the test input section 120 terminates the process.

As a result, a combination of the link designation 35 and the differential manipulation data group 36 corresponding to link identification information is outputted from the test input section 120. If a plurality of parameters are included in the <target data>, then the numbers of combinations of the link designation 35 and the differential manipulation data group 36 is equal to that of the plurality of parameters.

A default request generation process performed by the link identification and page reproduction section 131 which accepts the link designation 35 will be described.

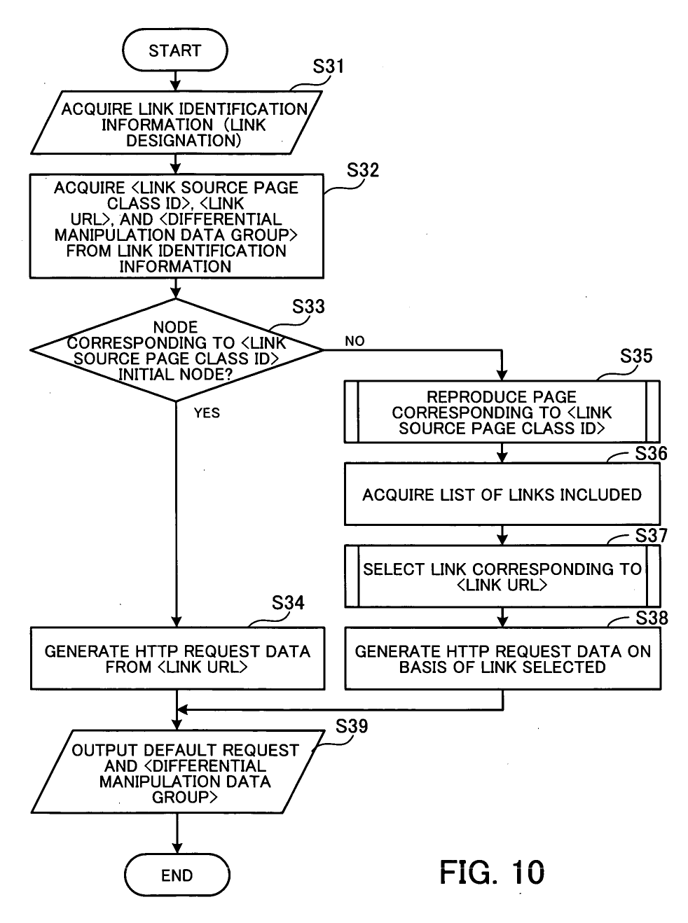

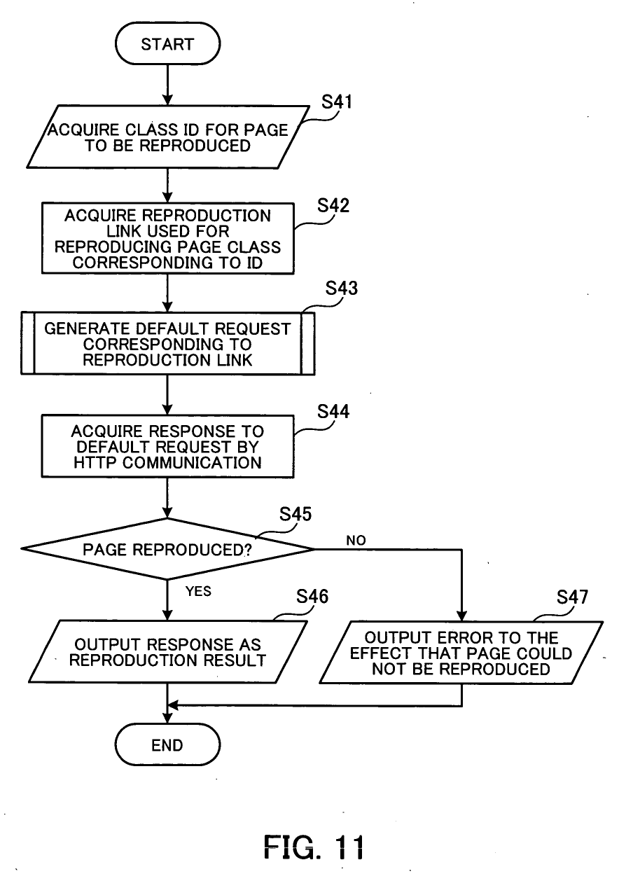

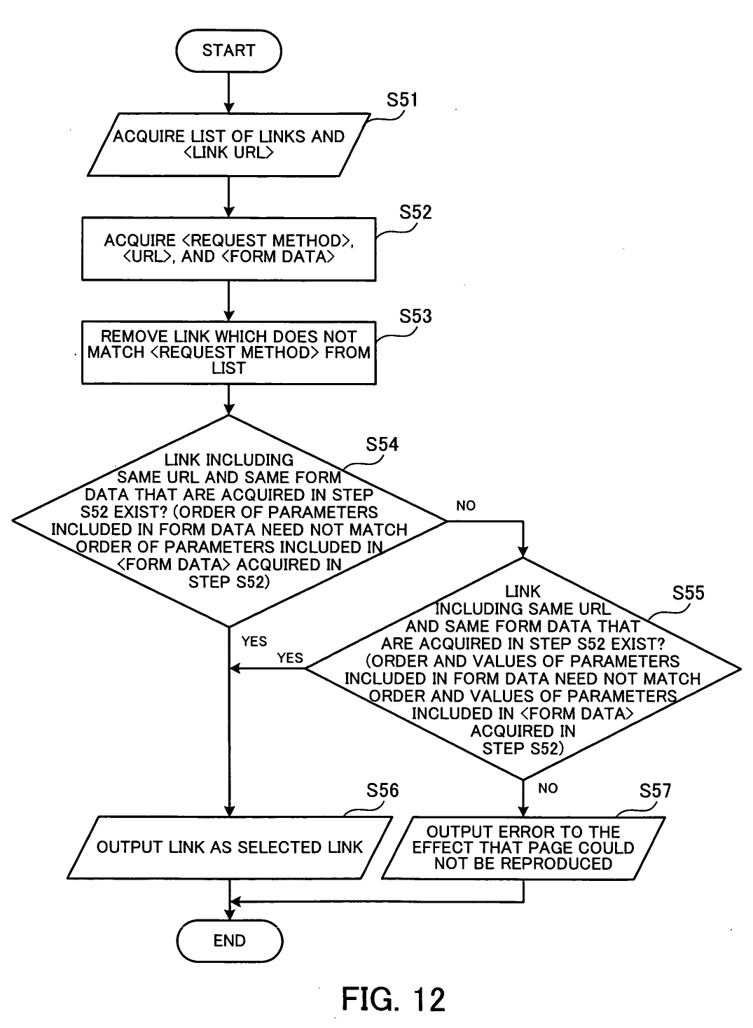

FIG. 10 is a flow chart showing the procedure for a default request generation process. The process shown in FIG. 10 will now be described in order of step number.

[Step S31] The link identification and page reproduction section 131 acquires link identification information from the link designation 35 inputted.

[Step S32] The link identification and page reproduction section 131 analyzes the link identification information it acquired, and acquires <link source page class ID>, a <link URL>, and a <differential manipulation data group>.

[Step S33] The link identification and page reproduction section 131 determines whether or not a node corresponding to the <link source page class ID> is an initial node. If the node is an initial node, then step S34 is performed. If the node is not an initial node, then step S35 is performed.

[Step S34] The link identification and page reproduction section 131 generates HTTP request data for acquiring a Web page from the <link URL> it acquired in step S32. Step S39 is then performed.

[Step S35] The link identification and page reproduction section 131 reproduces a page corresponding to the <link source page class ID>. The details of this step will be described later (see FIG. 11). If a page corresponding to the <link source page class ID> cannot be reproduced and an error is outputted, then the process shown in FIG. 10 terminates because of the error.

[Step S36] The link identification and page reproduction section 131 parses a response it acquired again in step S35, and acquires a list of link information included in the response. To “parse” data is the process of analyzing the data and extracting necessary data from the data.

[Step S37] The link identification and page reproduction section 131 selects link information corresponding to the <link URL> it acquired in step S32 from the list of link information it acquired in step S36. The details of this step will be described later (see FIG. 12).

[Step S38] The link identification and page reproduction section 131 generates HTTP request data generated by a Web browser at the time of the link information being selected on the basis of the link information it selected.

[Step S39] The link identification and page reproduction section 131 outputs the request data it generated to the differential manipulation application section 132 as the default request 42 and outputs the <differential manipulation data group> it acquired in step S32 to the differential manipulation application section 132 as the differential manipulation data group 41.

FIG. 11 is a flow chart showing the procedure for a page reproduction process. The process shown in FIG. 11 will now be described in order of step number.

[Step S41] The link identification and page reproduction section 131 acquires class ID indicated by the <link source page class ID> as class ID for a page to be reproduced.

[Step S42] The link identification and page reproduction section 131 acquires link identification data used for reproducing a page class corresponding to the class ID it acquired. As shown in FIG. 6, for example, the link identification and page reproduction section 131 holds in advance reproduction links associated with page classes as page class information. Accordingly, the link identification and page reproduction section 131 acquires a reproduction link associated with the page class ID to be reproduced from the page class information it stores in advance.

[Step S43] The link identification and page reproduction section 131 generates a default request indicative of a request to acquire a Web page corresponding to the reproduction link. To be concrete, the link identification and page reproduction section 131 recursively performs the default request generation process shown in FIG. 10 with the reproduction link as new input.

[Step S44] The link identification and page reproduction section 131 sends the default request via the HTTP communication section 133 and acquires a response to the default request.

[Step S45] The link identification and page reproduction section 131 determines whether or not the page is reproduced by data acquired by the response (whether or not data acquired is placed into the page class to be reproduced). To be concrete, a condition for falling under each page class is defined in the link identification and page reproduction section 131 and whether or not data acquired meets a condition for falling under the page class to be reproduced determines whether or not the page is reproduced. If the page is correctly reproduced, then step S46 is performed. If the page cannot be reproduced, then step S47 is performed.

[Step S46] The link identification and page reproduction section 131 outputs the response as a reproduction result. The page reproduction process then terminates.

[Step S47] The link identification and page reproduction section 131 outputs an error to the effect that the page could not be reproduced, and terminates the page reproduction process.

FIG. 12 is a flow chart showing the procedure for a link selection process. The process shown in FIG. 12 will now be described in order of step number.

[Step S51] The link identification and page reproduction section 131 acquires the list of links acquired in step S36 of FIG. 10 and the <link URL> acquired in step S32 of FIG. 10 extracted from the reproduced page.

[Step S52] The link identification and page reproduction section 131 acquires a <request method>, a <URL>, and <form data> from the <link URL>.

[Step S53] The link identification and page reproduction section 131 removes a link which does not match the <request method> it acquired in step S52 from the list of links. For example, if the <request method> is “GET”, then methods other than “GET”, such as “POST,” are removed.

[Step S54] The link identification and page reproduction section 131 determines whether or not a link including the same <URL> and the same <form data> that are acquired in step S52 is included in the list of links. In this case, the order of parameters included in <form data> need not match the order of parameters included in the <form data> acquired in step S52, but the values of the parameters included in the <form data> must match the values of the parameters included in the <form data> acquired in step S52. If a link including the same <URL> and the same <form data> that are acquired in step S52 is included in the list of links, then step S56 is performed. If a link including the same <URL> and the same <form data> that are acquired in step S52 is not included in the list of links, then step S55 is performed.

[Step S55] The link identification and page reproduction section 131 determines whether or not a link including the same <URL> and the same <form data> that are acquired in step S52 is included in the list of links. In this case, the order and values of parameters included in <form data> need not match the order and values of the parameters included in the <form data> acquired in step S52. If a link including the same <URL> and the same <form data> that are acquired in step S52 is included in the list of links, then step S56 is performed. If a link including the same <URL> and the same <form data> that are acquired in step S52 is not included in the list of links, then step S57 is performed.

[Step S56] The link identification and page reproduction section 131 outputs the link including the URL and the form data which match the <URL> and the <form data> it acquired in step S52 as a selected link. The link selection process then terminates.

[Step S57] The link identification and page reproduction section 131 outputs an error to the effect that a page could not be reproduced. The link selection process then terminates.

The differential manipulation data group 41 and the default request 42 are outputted from the link identification and page reproduction section 131 in the above way. For example, if the link identification information group 34 shown in FIG. 7 is inputted to the test input section 120 and the link (1,(POST,http://example.com/dynamic,control=123&data=1),[ ] by which an attempt to reproduce the page class 53 (see FIG. 6) having the page class ID “2” is made is inputted as the link designation 35, then default request is generated through the following procedure.

The link designation 35 inputted is not the initial node (ID “0”), so the link identification and page reproduction section 131 makes the determination “NO” in step S33 shown in FIG. 10. The link identification and page reproduction section 131 then proceeds to the process shown in FIG. 11. A <link source page class ID> included in the link designation 35 inputted is “1,” so in step S42 the link identification and page reproduction section 131 acquires the reproduction link (0,(GET,http://example.com/top,-),[ ]) for reproducing the page class 52 (see FIG. 6) having the page class ID “1.” In step S43 the link identification and page reproduction section 131 performs the process shown in FIG. 10 with the reproduction link for reproducing the page class 52 as link identification information to be processed. A <link source page class ID> included in the reproduction link (0,(GET,http://example.com/top,-),[ ]) for reproducing the page class 52 is the initial node (page class ID “0”), so the link identification and page reproduction section 131 makes the determination “YES” in step S33. As a result, in step S34 the link identification and page reproduction section 131 generates HTTP request data having the method attribute “GET” by which “http://example.com/top” is required as a default request. The default request generated is a processing result in step S43 in FIG. 11 from which the process is called.

In step S44 the link identification and page reproduction section 131 sends the default request it generated to the network 10 and acquires a response.

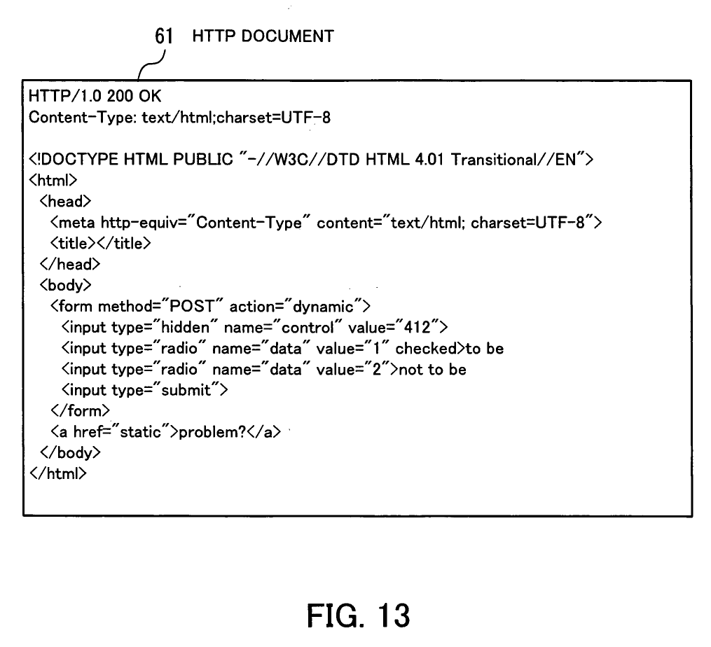

FIG. 13 shows an example of a response to the request. As shown in FIG. 13, an HTTP document 61 is obtained as a response. A list of links is generated from the HTTP document 61.

In the example shown in FIG. 13, a description between the <form> and </form> tags indicates a link. <input type=“radio” name=“data” value=“1” checked> shows that “1” is selected as the value of “data” by a radio button. Furthermore, a link is set by the anchor tag <a href=“static”>problem?</a>.

If a page which belongs to the page class 52 having the page class ID “1” is correctly reproduced as the response, then the link identification and page reproduction section 131 outputs the page as a reproduction result in step S46. The link identification and page reproduction section 131 then proceeds to step S36 shown in FIG. 10. That is to say, the link identification and page reproduction section 131 parses the reproduced page and acquires a list of links included in the page.

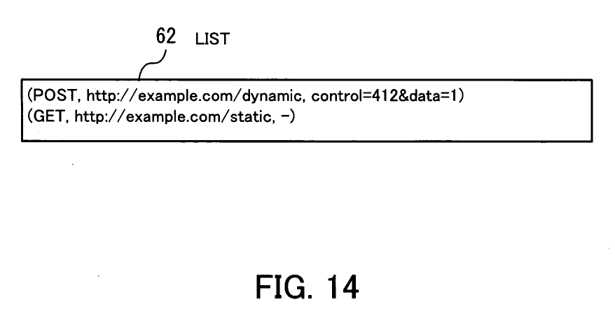

FIG. 14 shows a list of links included in the response. A list 62 includes a link corresponding to the POST method and a link corresponding to the GET method. The link corresponding to the POST method includes a link URL based on the description between the <form> and </form> tags in the HTTP document 61. The link corresponding to the GET method includes a link URL based on the description <a href=“static”>problem?</a> in the HTTP document 61.

By performing the process shown in FIG. 12, a link is selected from the list 62 acquired. In the case of the list 62 shown in FIG. 14, the reproduction link (1,(POST,http://example.com/dynamic,control=123&data=1),[ ] and each link URL included in the list 62 are compared. In this case, the link URL (POST,http://example.com/dynamic,control=123&data=1) matches the <URL> included in the reproduction link. The link identification and page reproduction section 131 then determines whether parameters included in the form data set in this link match the parameters included in the <form data> set in the reproduction link (step S55 in FIG. 12). In this case, the order and values of the parameters included in the form data set in this link need not match the order and values of the parameters included in the <form data> set in the reproduction link. The link identification and page reproduction section 131 makes the determination “YES” and this link is selected.

After this link is selected, HTTP request data is generated in step S38 in FIG. 10.

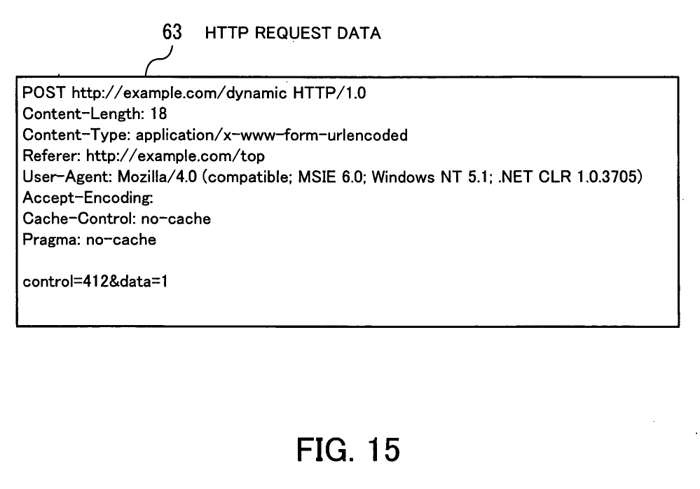

FIG. 15 shows an example of request data. Contents outputted from a predetermined Web browser at the time of a link being selected on the Web browser are set in HTTP request data 63. That is to say, by simulating a process performed by the Web browser at the time of a link being selected, the HTTP request data 63 is generated.

The HTTP request data 63 generated is passed to the differential manipulation application section 132 as the default request 42. The link (1,(POST,http://example.com/dynamic,control=123&data=1),[ ]) was inputted as the link designation 35 to generate the default request 42. A differential manipulation data group is not set in this link. Accordingly, when the HTTP request data 63 shown in FIG. 15 is outputted from the link identification and page reproduction section 131 as the default request 42, the differential manipulation data group 41 is not outputted.

If the link identification information (1,(POST,http://example.com/dynamic,control=213&data=1),[Form,change,data,1,2] included in the link identification information group 34 is inputted as the link designation 35, request data the contents of which are the same as those of the HTTP request data 63 shown in FIG. 15 is generated. The differential manipulation data group [Form,change,data,1,2] is included in this link identification information, so [Form,change,data,1,2] is outputted from the link identification and page reproduction section 131 as the differential manipulation data group 41.

The link identification information (1,(POST,http://example.com/dynamic,control=213&data=1),[Form,change,data,1,2] indicates a link used if a radio button defined by <input type=“radio” name=“data” value=“2”> included in the description between the <form> and </form> tags in the HTTP document 61 shown in FIG. 13 is selected.

If (POST,http://example.com/dynamic,control=123&data=1) is selected from the list 62 shown in FIG. 14 and the HTTP request data 63 shown in FIG. 15 is generated, then the HTTP request data 63 is passed to the differential manipulation application section 132 as the default request 42. The link URL 43 (POST,http://example.com/dynamic,control=123&data=1) from which the default request 42 is generated is also passed to the differential manipulation application section 132.

The differential manipulation application section 132 then determines a target which is included in the default request 42 and on which a differential manipulation is to be performed in accordance with the differential manipulation data groups 36 and 41. If “Method” is designated, then the first word in the first line of the HTTP request data 63 (“POST” in the example shown in FIG. 15) is specified as a target. If “URL” is designated, then a description in the first line of the HTTP request data 63 which follows the method (“http://example.com/dynamic” in the example shown in FIG. 15) is specified as a target. If “Form” is designated, then a description in the HTTP request data 63 (“control=123&data=1” in the ninth line of the example shown in FIG. 15) corresponding to the form data (control=123&data=1) included in the link URL 43 (POST,http://example.com/dynamic,control=123&data=1) is specified as a target. If “Query” is designated, then a description after “?” in the URL indicated in the first line of the HTTP request data 63 (query is not set in the example shown in FIG. 15) is specified as a target. If “Cookie” is designated, then a description in a line of the HTTP request data 63 which begins with “Cookie” (cookie is not set in the example shown in FIG. 15) is specified as a target. If “Referer” is designated, then a description in a line of the HTTP request data 63 (fourth line of the example shown in FIG. 15) which begins with “Referer” is specified as a target. If “Header” is designated, then a description in a header field line of the HTTP request data 63 which is indicated by a field name, such as “Content-Length” or “Content-Type,” is specified as a target.

A differential manipulation application process performed by the differential manipulation application section 132 will now be described. A process performed in the case of a query being specified as a target will be described as a typical differential manipulation application process.

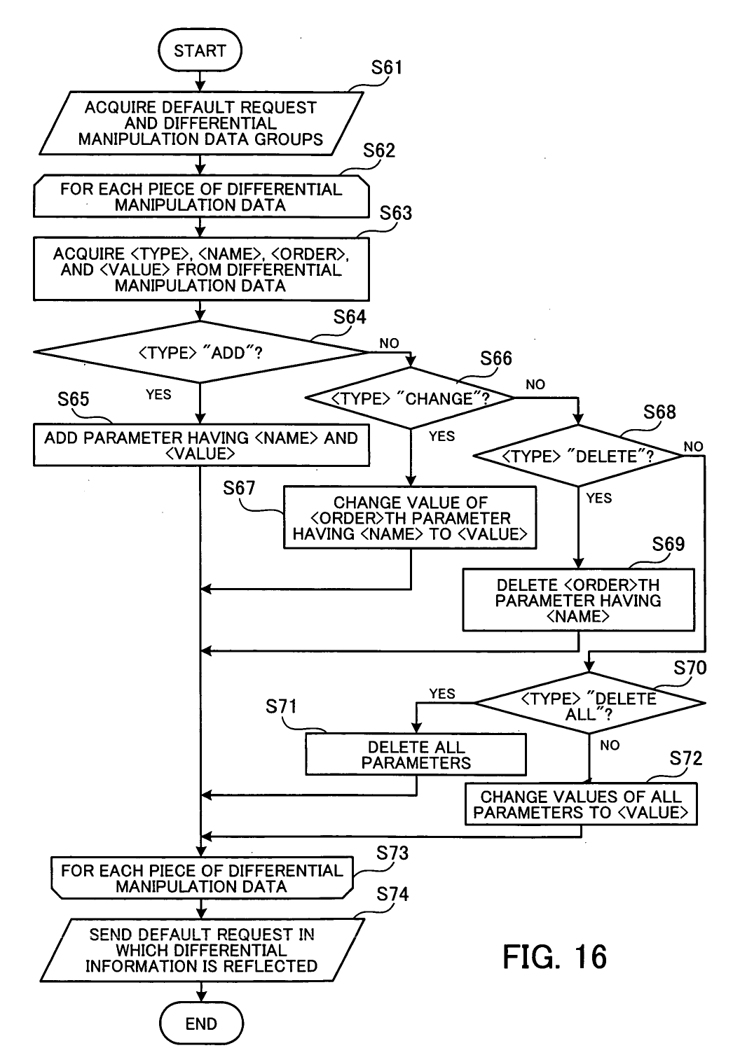

FIG. 16 is a flow chart showing the procedure for a differential manipulation application process. The process shown in FIG. 16 will now be described in order of step number.

[Step S61] The differential manipulation application section 132 acquires the default request 42 and the differential manipulation data groups 36 and 41 inputted.

[Step S62] The differential manipulation application section 132 performs steps S63 through S72 for each piece of differential manipulation data it acquired.

[Step S63] The differential manipulation application section 132 acquires data set in the <Type>, <Name>, <Order>, and <Value> fields in differential manipulation data.

[Step S64] The differential manipulation application section 132 determines whether or not the data set in the <Type> field is “add.” If the data set in the <Type> field is “add”, then step S65 is performed. If the data set in the <Type> field is not “add”, then step S66 is performed.

[Step S65] The differential manipulation application section 132 adds a query parameter having the name which is set in the <Name> field and which is acquired in step S63 to the end of a query of the default request. In this case, the differential manipulation application section 132 sets the value which is set in the <Value> field and which is acquired in step S63 for the query parameter added. Step S73 is then performed.

[Step S66] The differential manipulation application section 132 determines whether or not the data set in the <Type> field is “change.” If the data set in the <Type> field is “change”, then step S67 is performed. If the data set in the <Type> field is not “change”, then step S68 is performed.

[Step S67] The differential manipulation application section 132 extracts query parameters having the same name that is set in the <Name> field and that is acquired in step S63 from the query of the default request. The differential manipulation application section 132 then selects a query parameter the order of which is the same as the order that is set in the <Order> field and that is acquired in step S63 from among the query parameters extracted. The differential manipulation application section 132 set the data that is set in the <Value> field and that is acquired in step S63 as the value of the query parameter selected. Step S73 is then performed.

[Step S68] The differential manipulation application section 132 determines whether or not the data set in the <Type> field is “delete.” If the data set in the <Type> field is “delete”, then step S69 is performed. If the data set in the <Type> field is not “delete”, then step S70 is performed.

[Step S69] The differential manipulation application section 132 extracts query parameters having the same name that is set in the <Name> field and that is acquired in step S63 from the query of the default request. The differential manipulation application section 132 then selects a query parameter the order of which is the same as the order that is set in the <Order> field and that is acquired in step S63 from among the query parameters extracted. The differential manipulation application section 132 deletes the selected query parameter. Step S73 is then performed.

[Step S70] The differential manipulation application section 132 determines whether or not the data set in the <Type> field is “delete all.” If the data set in the <Type> field is “delete all”, then step S71 is performed. If the data set in the <Type> field is not “delete all”, then step S72 is performed. If the data set in the <Type> field is “change all”, the differential manipulation application section 132 makes the determination “NO” in step S70.

[Step S71] The differential manipulation application section 132 deletes all query parameters included in the default request. Step S73 is then performed.

[Step S72] The differential manipulation application section 132 changes the values of all query parameters included in the query of the default request to the value that is set in the <Value> field and that is acquired in step S63. Step S73 is then performed.

[Step S73] After the differential manipulation application section 132 performs steps S63 through S72 for all pieces of differential manipulation data, step S74 is performed.

[Step S74] The differential manipulation application section 132 sends the default request in which the differential information is reflected to the Web server 21 via the HTTP communication section 133 and outputs a response to the default request to the test result decision section 140 as the HTTP response.

The differential manipulation process can be performed on the default request in this way. In the embodiment of the present invention, it is assumed that the differential manipulation data group 41 provided by the link identification and page reproduction section 131 is preferentially applied and that the differential manipulation data group 36 provided by the test input section 120 is applied next.

The process shown in FIG. 16 is performed if “Query” is designated as a target for a differential manipulation. By performing the same process, however, a differential manipulation can be applied to other targets. If “Form” is designated as a target for a differential manipulation, a query parameter should be replaced with a form data parameter.

There is a limit to the type of a manipulation for some targets. For example, only “change all” can be used for “Method,” “URL,” and “Referer” as a manipulation type. In this case, the differential manipulation application section 132 always makes the determination “NO” in steps S64, S66, and S68 in the flow chart shown in FIG. 16.

If “Header” is designated as a target for a differential manipulation, the description of the flow chart shown in FIG. 16 can be applied by changing “query” and “query parameter” to “header” and “header field” respectively.

In the embodiment of the present invention, the order in which differential manipulation data groups are applied is determined according to the type of a target. That is to say, the order in which differential manipulation data groups are selected and applied is “Method,” “URL,” “Form,” “Query,” “Cookie,” “Referer,” and “Header.” This order is determined mainly with intelligibility taken into consideration.

By the way, the test input section 120 can also set the differential manipulation data group 36 by manual operation. For example, when arbitrary link identification information is selected from the link identification information group 34 by operation input from a user, the test input section 120 displays a differential manipulation main screen.

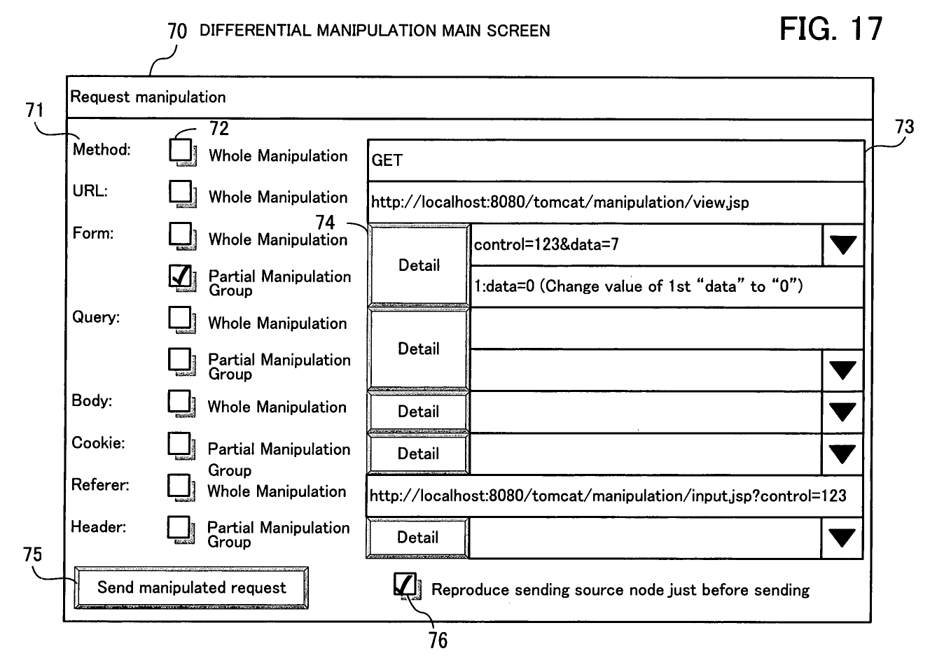

FIG. 17 shows a differential manipulation main screen. A differential manipulation main screen 70 is one of GUIs for manual input provided by the differential manipulation application section 132 and displays an overview of a differential manipulation to be performed on the selected link identification information.

Operation targets 71, such as “Method:,” are displayed on the differential manipulation main screen 70. A check box 72 for specifying whether to perform a differential manipulation is associated with each manipulation target 71 according to type which indicates that the contents of the manipulation is whole manipulation or a partial manipulation group. The type “whole manipulation” indicates that differential manipulation data for “change all” is set. The type “partial manipulation group” indicates that a differential manipulation data group for a change process other than “change all” is set. When each check box 72 is selected by operation input from a user, a check mark is displayed therein.

A text box 73 corresponding to each manipulation item (whole manipulation or partial manipulation group) is located. Contents after the change process by the differential manipulation can be set in the text box 73 by operation input. A value corresponding to the selected link identification information is displayed in each text box 73 as the initial value of each item.

Detail buttons 74 corresponding to manipulation targets such as “Form:” are located. When each Detail button 74 is pressed, a detail editing screen is displayed.

A settling button 75 on which the words “Send manipulated request” are written is used for giving instructions to send a request to which the differential manipulation has been applied. When the settling button 75 is pressed, a request to which the differential manipulation set on the differential manipulation main screen 70 has been applied is sent to the Web server via the network 10. That is to say, when the settling button 75 is clicked, the test input section 120 inputs the differential manipulation data group which is being displayed to the Web page acquisition section 130 with the selected link identification information. The differential manipulation application section 132 applies the differential manipulation data to the default request 42 in order from the top (whole manipulation of Method→whole manipulation of URL→whole manipulation of Form→partial manipulation of Form→ . . . ).

A check box 76 beside the words “Reproduce sending source node just before sending” are written is used for giving instructions to reproduce a sending source node. When the settling button 75 is pressed with the check box 76 selected, the link identification and page reproduction section 131 performs the process of reproducing a class from which the request to be sent was sent. After that, the request to which the differential manipulation has been applied is sent.

“Form” is data designated by the HTML form. “Query” is data designated as part of a URL (query parameter after “?”).

The detail editing screen will now be described.

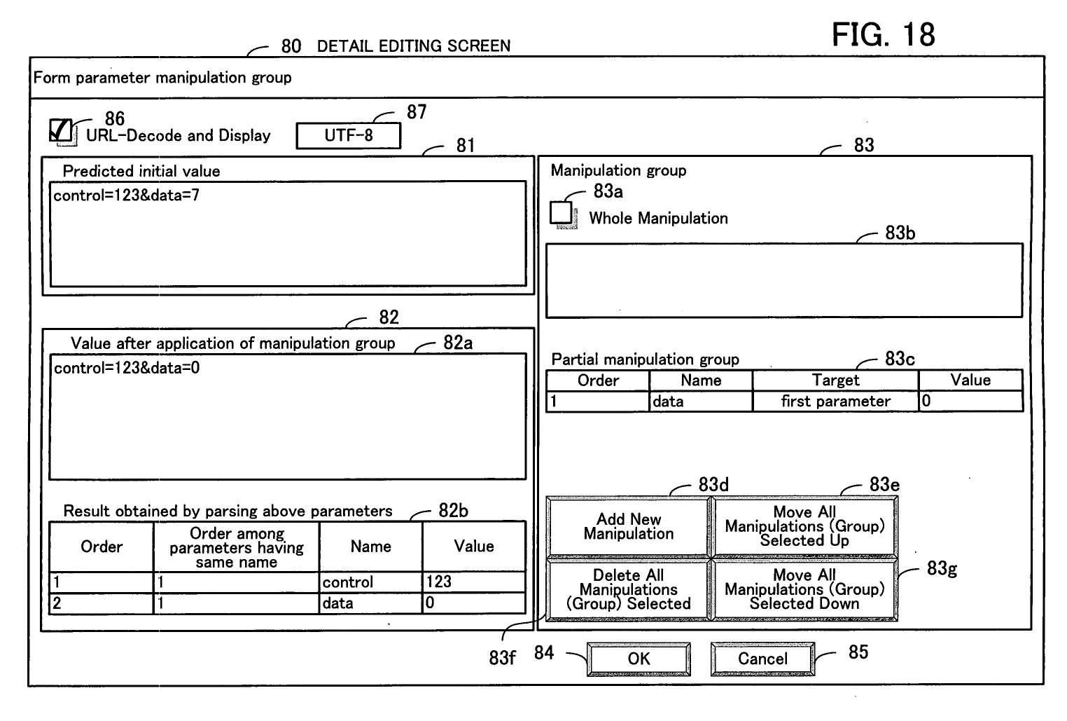

FIG. 18 shows a detail editing screen. A detail editing screen 80 is displayed when the Detail button 74 corresponding to “Form” is pressed. An initial value display section 81 in which the words “Predicted initial value” are written is located at the upper left of the detail editing screen 80. Form parameters acquired from the selected link identification information are displayed in the initial value display section 81.

A differential manipulation result display section 82 in which the words “Value after application of manipulation group” are written is located below the initial value display section 81. Values obtained by applying differential manipulation data set in a manipulation area 83 to “predicted initial values” are displayed in an applied value display section 82a of the differential manipulation result display section 82. The parameters to which the differential manipulation has been applied are parsed and are displayed in an easy-to understand table form in a parsing result display section 82b below the applied value display section 82a which is titled “Result obtained by parsing above parameter.”

The manipulation area 83 at the right of the detail editing screen 80 in which the words “Manipulation group” are written is an input area where the differential manipulation is set. A Whole Manipulation check box 83a is located in the manipulation area 83. If the type of the differential manipulation is “change all”, the Whole Manipulation check box 83a is checked. When the Whole Manipulation check box 83a is selected, the contents of the Form parameters after the change are set in a whole manipulation input section 83b.

To apply a partial manipulation group, a user sets the contents of a parameter after the change in a parameter input section 83c titled “Partial manipulation group” instead of selecting the Whole Manipulation check box 83a. The parameter input section 83c includes “Order,” “Name,” “Target,” and “Value” columns. Pieces of data horizontally arranged in these columns are associated with one another and make up a piece of differential manipulation data.

Order in which differential manipulations are applied is indicated in the “Order” column. The name of the parameter to be changed is indicated in the “Name” column. Where the parameter to be changed is from the head of the parameters having the same name is set in the “Target” column. The value of the parameter to which the differential manipulation has been applied is set in the “Value” column.

An Add button 83d on which the words “Add New Manipulation” are written is used for adding new differential manipulation data. When the Add button 83d is pressed, a partial manipulation input screen is displayed and differential manipulation data inputted thereon is added to a new line in the parameter input section 83c.

A Move button 83e on which the words “Move All Manipulations (Group) Selected Up” are written is used for moving a selected differential manipulation data line up. A button 83f on which the words “Delete All Manipulations (Group) Selected” are written is used for deleting a selected differential manipulation data line. A Move button 83g on which the words “Move All Manipulations (Group) Selected Down” are written is used for moving a selected differential manipulation data line down.

An OK button 84 and a Cancel button 85 are located at the bottom of the detail editing screen 80. When the OK button 84 is pressed, contents inputted on the detail editing screen 80 are settled and are reflected on the differential manipulation main screen 70. When the Cancel button 85 is pressed, the contents inputted on the detail editing screen 80 are not reflected on the differential manipulation main screen 70 and the detail editing screen 80 closes.

In the example shown in FIG. 18, one partial manipulation made up of the type “change,” the name “data,” the order “1,” and the value “0” is set as differential manipulation data. The test input section 120 calculates a “value after the application of the manipulation group” from the “predicted initial value” by performing the same process that is shown in FIG. 16. This “value after the application of the manipulation group” is displayed in the differential manipulation result display section 82. A portion changed may be highlighted in the differential manipulation result display section 82 (for example, if usually black letters are used, a portion changed is displayed in red letters).

In addition, a check box 86 is located in the upper left-hand corner of the detail editing screen 80 shown in FIG. 18 and the words “URL-Decode and Display” are written beside it. The check box 86 is used for designating a letter decoding system. If the check box 86 is selected, each piece of data which has been decoded by a letter decoding system designated in a text box 87 is displayed.

The detail editing screen 80 displayed at the time of pressing the Detail button corresponding to “Form” is shown in FIG. 18. However, editing is performed on a detail editing screen that is almost the same as the detail editing screen 80 shown in FIG. 18 for an item other than “Form.” Only “whole manipulation” can be designated for, for example, “Method.” In addition, “whole manipulation” cannot be designated for, for example, “Cookie.” In the case of “Cookie”, the “Cookie” (NAME=VALUE) is a unit of manipulation. In the case of “Header”, the field line (“field-name”: “field-value”) is a unit of manipulation.

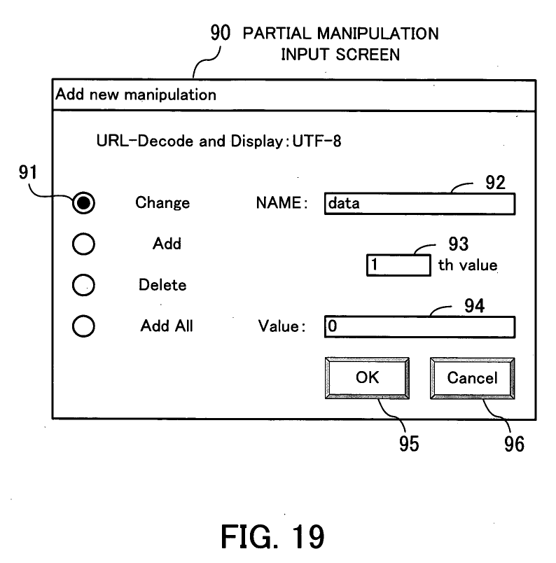

FIG. 19 shows a partial manipulation input screen. A partial manipulation input screen 90 is displayed when the Add button 83d shown in FIG. 18 is selected or when double-clicking is performed in an arbitrary line in the parsing result display section 82b.

The partial manipulation input screen 90 is a GUI for adding a partial manipulation. A check box 91 for selecting each manipulation type is located on the partial manipulation input screen 90. The name of a parameter to be changed is entered in a text box 92 beside the word “Name.” Where the parameter to be changed is from the head of parameters having the same name is entered in a text box 93 below the text box 92. The value after the change of the parameter to be changed is entered in a text box 94 below the text box 93.

When an OK button 95 is pressed, contents set on the partial manipulation input screen 90 are settled and are reflected on the detail editing screen 80. When a Cancel button 96 is pressed, the contents set on the partial manipulation input screen 90 are not reflected on the detail editing screen 80 and the partial manipulation input screen 90 closes. The words “URL-Decode and Display” displayed in the upper part of the partial manipulation input screen 90 shown in FIG. 19 indicate that each piece of data which has been decoded by the letter decoding system is displayed.

On the partial manipulation input screen 90, a user selects a check box 91 corresponding to the type set in the <Type> field included in the differential manipulation data, sets a <name>, a <order>, and a <value>, and presses the OK button 95. By doing so, the user can add a new partial manipulation to the detail editing screen 80.

As has been described in the foregoing, with the embodiment of the present invention a test request including a parameter having a value which cannot be set via a browser can be generated. Moreover, by setting differential manipulation data, a test request can be generated by batch processing. To be concrete, the test definition analysis section 110 to which the test definition 31 is inputted should wait until predetermined time and output the test input rule definition 32 and the result decision rule definition 33. In this case, it is assumed that the link identification information group 34 to be processed is designated in advance for the test input section 120.

In addition, a page from which a request was sent is reproduced and a differential manipulation is applied to a default request generated form the reproduced page. Accordingly, there is no need to manipulate values, such as a session token, by sessions. That is to say, the values of a session token and the like at page reproduction time are used. As a result, sending can be performed by using a proper value in each session. This enables a test by batch processing.

Furthermore, with the embodiment of the present invention differential manipulation data is set according to parameter and plural pieces of differential manipulation data can be applied to one request. As a result, a differential manipulation can be designated flexibly.

The above functions can be realized with a computer. In this case, a program in which the contents of the functions the test support apparatus should have are described is provided. By executing this program on the computer, the above functions are realized on the computer. This program can be recorded on a computer-readable medium. A computer-readable medium can be a magnetic recording device, an optical disk, a magneto-optical recording medium, a semiconductor memory, or the like. A magnetic recording device can be a hard disk drive (HDD), a flexible disk (FD), a magnetic tape, or the like. An optical disk can be a digital versatile disk (DVD), a digital versatile disk random access memory (DVD-RAM), a compact disk read only memory (CD-ROM), a compact disk recordable (CD-R)/rewritable (CD-RW), or the like. A magneto-optical recording medium can be a magneto-optical disk (MO) or the like.

To place the program on the market, portable record media, such as DVDs or CD-ROMs, on which it is recorded are sold. Alternatively, the program is stored in advance on a hard disk in a server computer and is transferred from the server computer to another computer via a network.

When the computer executes this program, it will store the program, which is recorded on a portable record medium or which is transferred from the server computer, on, for example, its hard disk. Then the computer reads the program from its hard disk and performs processes in compliance with the program. The computer can also read the program directly from a portable record medium and perform processes in compliance with the program. Furthermore, each time the program is transferred from the server computer, the computer can perform processes in turn in compliance with the program it receives.

In the present invention editing is performed on a default request generated on the basis of link identification information according to differential manipulation data. By doing so, a test request is generated. Therefore, a test request including data which cannot be set by operation input to a browser that displays a link source page can be generated. In addition, by inputting the differential manipulation data in advance, the default request is automatically edited. As a result, there is no need to perform operation input each time request data is generated, and batch processing can be performed.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable medium storing a test support program for supporting a test for a page provided by a server on a network, the program causing a computer to function as:
a link identification information acquisition section for accepting input of link identification information necessary for tracing a link from a link source page to a page to be tested;
a link identification information storage section for storing the link identification information inputted to the link identification information acquisition section;
a differential manipulation data acquisition section for accepting input of differential manipulation data indicative of contents of a manipulation performed on data to be changed included in a default request;
a differential manipulation data storage section for storing the differential manipulation data inputted to the differential manipulation data acquisition section;
a default request generation section for generating request data for accessing the page to be tested on the basis of the link identification information stored in the link identification information storage section and for outputting the request data generated as the default request;
a test request generation section for generating a test request by editing the default request outputted from the default request generation section in accordance with the contents of the manipulation regarding the data to be changed indicated by the differential manipulation data stored in the differential manipulation data storage section; and
a request sending section for sending the test request generated by the test request generation section via the network.

2. The computer-readable medium according to claim 1, the program further causing the computer to function as:
a link relationship storage section for storing in advance a link relationship between pages provided by the server; and
a link source page reproduction section for determining the link source page by referring to the link relationship storage section and for reproducing the link source page by accessing the server,
wherein the default request generation section extracts link identification information corresponding to the link identification information inputted from the link source page reproduced by the link source page reproduction section and generates request data on the basis of the link identification information extracted.

3. The computer-readable medium according to claim 2, wherein the default request generation section analyzes the link source page reproduced by the link source page reproduction section, extracts link identification information indicative of a link from the link source page to a second page, selects link identification information in which at least names of parameters are the same from the link identification information extracted, and generates request data on the basis of the link identification information selected.

4. The computer-readable medium according to claim 1, wherein if parameter change instructions by which a name of a parameter to be changed and a value after a change of the parameter to be changed are designated are indicated in the differential manipulation data, the test request generation section detects a parameter having the name of the parameter to be changed in the default request and generates the test request by changing a value of the parameter detected to the value after the change of the parameter to be changed.

5. The computer-readable medium according to claim 1, further making the computer function as a test input section for extracting, at the time of a test input rule definition including a data type of data to be manipulated and a value to which the data to be manipulated is set and the link identification information being inputted, a parameter corresponding to the data type from the link identification information, for generating the differential manipulation data which indicates that a value of the parameter extracted is changed to the value to which the data to be manipulated is set, and for outputting the differential manipulation data generated to the differential manipulation data acquisition section.

6. The computer-readable medium according to claim 1, further making the computer function as a test result decision section, to which a result decision rule definition indicative of a criterion for deciding whether a response to the test request is correct is inputted in advance, for acquiring a response to the test request sent from the request sending section and for deciding on the basis of the result decision rule definition whether contents of the response are correct.

7. The computer-readable medium according to claim 1, further making the computer function as:
a test input section for extracting, at the time of a test input rule definition including a data type of data to be manipulated and a value to which the data to be manipulated is set and the link identification information being inputted, a parameter corresponding to the data type from the link identification information, for generating the differential manipulation data which indicates that a value of the parameter extracted is changed to the value to which the data to be manipulated is set, and for outputting the differential manipulation data generated to the differential manipulation data acquisition section;
a test result decision section, to which a result decision rule definition indicative of a criterion for deciding whether a response to the test request is correct is inputted in advance, for acquiring a response to the test request sent from the request sending section and for deciding on the basis of the result decision rule definition whether contents of the response are correct; and
a test definition analysis section for extracting, at the time of a test definition including the test input rule definition and the result decision rule definition being inputted, the test input rule definition from the test definition, for outputting the test input rule definition extracted to the test input section, for extracting the result decision rule definition from the test definition, and for outputting the result decision rule definition extracted to the test result decision section.

8. The computer-readable medium according to claim 7, wherein after the test definition analysis section checks that predetermined time has arrived, the test definition analysis section outputs the test input rule definition and the result decision rule definition to the test input section and the test result decision section respectively.

9. The computer-readable medium according to claim 1, wherein:
the differential manipulation data acquisition section accepts input of the differential manipulation data including a name of a parameter to be changed and a order of the parameter to be changed among parameters having the same name; and
the test request generation section performs editing on a parameter a order of which is designated in the differential manipulation data included in the default request among parameters having the name indicated in the differential manipulation data included in the default request.

10. A test support apparatus for supporting a test for a page provided by a server on a network, the apparatus comprising:
a link identification information acquisition section for accepting input of link identification information necessary for tracing a link from a link source page to a page to be tested;
a link identification information storage section for storing the link identification information inputted to the link identification information acquisition section;
a differential manipulation data acquisition section for accepting input of differential manipulation data indicative of contents of a manipulation performed on data to be changed included in a default request;
a differential manipulation data storage section for storing the differential manipulation data inputted to the differential manipulation data acquisition section;
a default request generation section for generating request data for accessing the page to be tested on the basis of the link identification information stored in the link identification information storage section and for outputting the request data generated as the default request;
a test request generation section for generating a test request by editing the default request outputted from the default request generation section in accordance with the contents of the manipulation regarding the data to be changed indicated by the differential manipulation data stored in the differential manipulation data storage section; and
a request sending section for sending the test request generated by the test request generation section via the network.

11. A test support method for supporting a test for a page provided by a server on a network, the method comprising the steps of:
accepting input of link identification information necessary for tracing a link from a link source page to a page to be tested, and storing the link identification information inputted;
accepting input of differential manipulation data indicative of contents of a manipulation performed on data to be changed included in a default request, and storing the differential manipulation data inputted;
generating request data for accessing the page to be tested on the basis of the link identification information stored, and outputting the request data generated as the default request;
generating a test request by editing the default request outputted in accordance with the contents of the manipulation regarding the data to be changed indicated by the differential manipulation data; and
sending the test request generated via the network.
